(19) United States
(12) Patent Application Publication
(10) Pub. No.: US 2024/0215561 A1
(43) Pub. Date: Jul. 4, 2024

(54) LINE-WINDING DEVICE, FISHING REEL, AND WINCH

(71) Applicant: GLOBERIDE, INC., Higashi Kurume-shi, Tokyo (JP)

(72) Inventors: Hiromu YASUDA, Higashi Kurume-shi (JP); Ryo OOIGAWA, Higashi Kurume-shi (JP)

(73) Assignee: GLOBERIDE, INC., Higashi Kurume-shi, Tokyo (JP)

(21) Appl. No.: 18/288,229

(22) PCT Filed: Dec. 6, 2021
(86) PCT No.: PCT/JP2021/044656

§ 371 Date: Oct. 25, 2023

(30) Foreign Application Priority Data
Apr. 27, 2021 (JP) 2021-074978

(51) Int. Cl. A01K 97/12; A01K 89/01; A01K 89/012

(52) U.S. Cl. CPC A01K 97/125; A01K 89/0108; A01K 89/0121

(57) ABSTRACT

A line-winding device is a line-winding device for fishing capable of being fixed to a fishing rod, the line-winding device including: a spool capable of winding a fishing line around a central axis substantially parallel to an extending direction of the fishing rod; a rotor including a guide part for guiding the fishing line and rotatable around the spool; an operating part for rotationally operating the guide part; and a switching part for switching availability of guiding by the guide part, and including: a support shaft portion that pivotally supports the spool rotatably and is rotatably supported with respect to a device main body; a restoration unit for applying a restoring force between the support shaft portion and the spool; and a detection unit for detecting an angular position of the support shaft portion.

### TECHNICAL FIELD

The present invention relates to a line-winding device, a fishing reel, and a winch capable of detecting tension with high accuracy even at the time of stopping.

### BACKGROUND ART

In a line-winding device such as a fishing reel, by detecting a tension of a line, it is possible to prevent line entanglement by detecting the presence or absence of line slack, and to perform fishing efficiency by detecting the presence or absence of fish strike. Conventionally, various methods have been proposed as a method for detecting the tension of the line.

For example, Patent Literature 1 discloses a tubular rod body constituting a fishing rod used for fishing, the rod body including: a tubular main body portion formed by firing a prepreg material in which carbon fibers are impregnated with a synthetic resin; a piezoelectric element band extending in an axial direction and disposed on a peripheral surface of the main body portion; a bottom plug detachably attached to a rod base side end of the main body portion; and a boosting means for boosting an input voltage from the piezoelectric element band disposed in the bottom plug, in which a first electrode layer, an insulating layer, a light emitting layer, a second electrode layer, and a surface layer are laminated in this order from the peripheral surface of the main body portion on the peripheral surface of the main body portion, and a voltage from the boosting means pressurizes between the first electrode layer and the second electrode layer.

Further, Patent Literature 2 discloses a fishing sensor including: a detection unit that detects vibrations applied to a fishing line due to a bite of a fish; and a means of converting the detected signal into an electrical signal, inputting it to a signal processing circuit, and converting analog changes in the processed signal into a different type of sound or light.

Furthermore, Patent Literature 3 discloses a fishing reel including: a rotating body that winds a fishing line; a bearing portion that allows displacement of the rotating body corresponding to a tension acting on the fishing line from the rotating body; a sensor that measures the tension acting on the fishing line based on the displacement of the rotating body; and a notification device that outputs a measurement result from the sensor, in which the notification device and the sensor each is housed in a single waterproof case.

### CITATION LIST

### Patent Literature

Patent Literature 1: JP 2004-008005 A
Patent Literature 2: JP S64-037238 A
Patent Literature 3: JP H-05-184271 A

### SUMMARY OF INVENTION

### Technical Problem

However, in the rod body according to Patent Literature 1, deflection and vibration of the rod body are detected with the rod body as a detection target, but there is a problem that the deflection and vibration can be detected only when the rod body is at a specific position, for example, they cannot be detected when the rod body and the fishing line are straightened.

Further, in the fishing sensor according to Patent Literature 2, the fishing line is set as a detection target, the fishing line is bent by providing a guide part such as a pulley, and a force applied to the outside by the tension is detected at the bent point, however, since it is necessary to bend a line path for detecting the tension, there is a problem that it can be a resistance when it is desired to feed the fishing line at a high speed such as during casting, and it is difficult to miniaturize the entire tackle.

Furthermore, in the fishing reel according to Patent Literature 3, since the rotating body can be displaced by an external force other than the tension, there is a problem that it is practically difficult to detect an accurate tension from the displacement of the rotating body.

The present invention has been made in view of the above circumstances, and an object of the present invention is to provide a line-winding device comprising a tension detection unit that can be incorporated in a reel, can be downsized, and can measure a tension with high accuracy even at the time of stopping without the need to bend the line path. Objects of the present invention other than the object will be apparent by reference to the entire specification.

### Solution to Problem

The line-winding device according to an embodiment of the present invention is a line-winding device for fishing capable of being fixed to a fishing rod, the line-winding device comprising: a spool capable of winding a fishing line around a central axis substantially parallel to an extending direction of the fishing rod; a rotor comprising a guide part for guiding the fishing line and rotatable around the spool; an operating part for rotationally operating the guide part; and a switching part for switching availability of guiding by the guide part, and configured to comprise: a support shaft portion that is disposed at a central axis of the spool and is rotatably supported with respect to a device main body; a restoration unit for applying a restoring force between the support shaft portion and the device main body; and a detection unit for detecting an angular position of the support shaft portion. Further, in the line-winding device according to an embodiment of the present invention, the support shaft portion is configured such that a rotatable range of the support shaft portion is restricted by a rotation restricting part.

In the line-winding device according to an embodiment of the present invention, the restoration unit is an elastic spring (for example, a coil spring, a torsion spring, or the like).

In the line-winding device according to an embodiment of the present invention, the detection unit is a non-contact position detection means, and comprises a light emitting part for projecting light to a part to be detected, and a receiver for receiving light of the light emitting part.

In the line-winding device according to an embodiment of the present invention, a permanent magnet is provided in a part to be detected, and the detection unit is a non-contact position detection means, and is a magnetic detection unit for detecting magnetism of the permanent magnet provided in the part to be detected.

In the line-winding device according to an embodiment of the present invention, a sound wave reflecting part is provided in a part to be detected, and the detection unit is a non-contact position detection means, and is a sound wave detection unit for detecting a sound wave from the sound wave reflecting part provided in the part to be detected.

In a fishing reel according to an embodiment of the present invention, the fishing reel is any one of the above line-winding devices.

In a winch according to an embodiment of the present invention, the winch is any one of the above line-winding devices.

### Advantageous Effects of Invention

According to the embodiments described above, it is possible to provide the line-winding device comprising the tension detection unit that can be incorporated in the reel, can be downsized, and can measure a tension with high accuracy even at the time of stopping without the need to bend the line path.

### BRIEF DESCRIPTION OF DRAWINGS

FIG. 1 is a cross-sectional view taken along a cross-section passing through a central axis of configuration of a line-winding device 100 according to an embodiment of the present invention.

FIG. 2 is a cross-sectional view of a restoration unit of the line-winding device according to an embodiment of the present invention taken along a plane orthogonal to a support shaft.

FIG. 3 is a cross-sectional view taken along the cross-section passing through the central axis of configuration of the line-winding device 100 according to an embodiment of the present invention.

FIG. 4 is a cross-sectional view taken along the cross-section passing through the central axis of configuration of the line-winding device 100 according to an embodiment of the present invention.

### DESCRIPTION OF EMBODIMENTS

Hereinafter, an embodiment of a line-winding device according to the present invention will be specifically described with reference to the accompanying drawings. Components common in a plurality of drawings are denoted by the same reference signs throughout the plurality of drawings. It should be noted that the drawings are not necessarily drawn to scale for convenience of description.

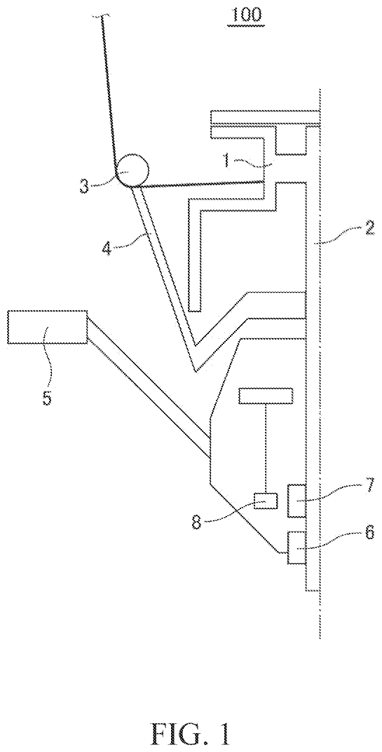

First, a configuration of a line-winding device 100 according to an embodiment of the present invention will be described with reference to FIG. 1 Note that in order to simplify the description, only a portion of a tension detection mechanism will be described in the following description, and a description of portions similar to those of the conventional line-winding device will be omitted. First, FIG. 1 illustrates a cross-sectional view taken along a cross-section passing through a central axis of configuration of a line-winding device 100.

As illustrated in FIG. 1, the line-winding device 100 according to an embodiment of the present invention comprises a spool 1, a support shaft portion (support shaft) 2, a rotor 4 having a line guide (guide part) 3, an operating part 5 (for example, a handle) for operating the rotor 4, a restoration unit (restoration means) 6, a part to be detected (means to be detected) 7, and a detection unit (a detection means) 8. The spool 1 is formed in a cylindrical shape, and is configured to be able to wind a fishing line by an outer peripheral portion of the spool. Note that in the following description, a central axis direction of the spool 1 is defined as an axial direction, and a rotation direction of the spool is defined as a rotation direction.

The support shaft portion 2 is formed in a substantially columnar shape, and in an embodiment of the present invention, the support shaft portion 2 and the spool 1 are coaxially fixed. Further, the support shaft portion 2 is rotatably supported with respect to a reel main body.

The line guide 3 is a known one capable of guiding the fishing line, and is supported on the rotor 4 via a conventionally known bail arm (not illustrated) By opening and closing the bail arm, availability of guiding of the fishing line by the line guide 3 can be switched by a switching means (a bail), the fishing line wound around the spool 1 can be released in an open state, and the fishing line can be wound around the spool 1 in a closed state.

The rotor 4 is rotatably supported with respect to the reel main body by a rotation shaft coaxial with the spool 1. The handle 5 can rotationally operate the rotor 4 according to an operation of a user, and constitutes an operating means in an embodiment of the present invention. Note that the rotation direction and a gear ratio may be converted using a transmission mechanism such as a gear as necessary. In addition, by preventing reverse rotation of the rotor 4 using a ratchet, a one-way clutch, or the like, unexpected release of the fishing line may be prevented. As the operating means, a power source such as a motor or an engine may be used in addition to the handle. In an embodiment of the present invention, a conventionally known operating means can be used, and thus further detailed description will be omitted.

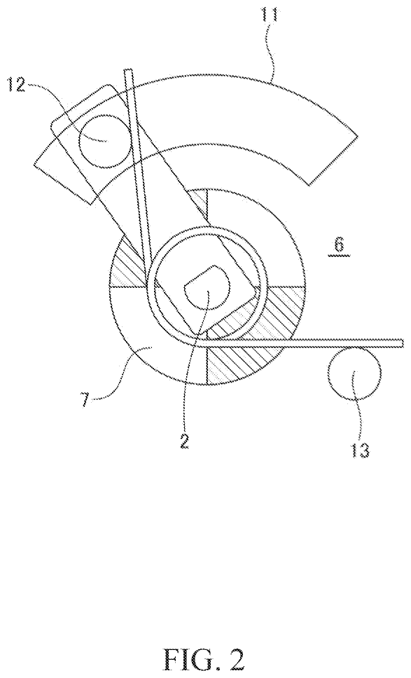

The restoration unit (restoration means) 6 is a means for generating a restoring force when the support shaft portion 2 moves in the rotation direction, and can be formed by a spring member (for example, the torsion spring) in an embodiment of the present invention. FIG. 2 is a cross-sectional view taken along a plane orthogonal to the support shaft, for explaining a detailed structure of the restoration unit.

The restoration unit 6 has one end in contact with a movable-side spring end 12 and the other end in contact with a fixed-side spring end 13. The movable-side spring end 12 moves in synchronization with the support shaft portion 2 in the rotation direction by a rotation stop shape such as a D-cut shape. Further, a movable range of the movable-side spring end 12 is restricted to a predetermined range of angle (for example, 0° to 60°) by a rotation restricting part 11 provided in the reel main body. Hereinafter, this angle is defined as θ. When the torsion spring is used as the restoration unit 6, a coil central axis of the spring is coaxial with the support shaft portion 2, so that a rotational movement amount θ of the support shaft portion 2 and a torque acting on the support shaft portion 2 can be in a proportional relationship. In addition, by using the torsion spring, it is possible to generate a predetermined restoring force with small size and low cost. Note that the restoration unit 6 is not limited to the torsion spring, and an elastic spring using an elastic force of an object as the restoring force, such as a compression coil spring, a tension coil spring, a spiral spring, or a leaf spring, and a magnetic spring using a magnetic force as the restoring force, and the like can be used.

Further, the fixed-side spring end 13 is provided in the reel main body. Thus, the restoration unit 6 can generate the restoring force between the support shaft portion and the reel main body. In an embodiment of the present invention, it is configured such that θ=0° when the torque acting on the spool is 10 gem or less, θ=60° when the torque acting on the spool is 100 gem or more, and an angle change is linearly generated as the torque increases between 0° and 60°.

The part to be detected (means to be detected) 7 moves in synchronization with the support shaft portion in the rotation direction by the rotation stop shape such as the D-cut shape. Note that the part to be detected may be configured integrally with the movable side spring end. Displacement of the part to be detected 7 in the rotation direction can be detected by the detection unit 8. In an embodiment of the present invention, a reflector having different reflectance for each predetermined angle is used as the part to be detected 7, and a reflective photosensor is used as the detection unit 8. As a method of implementing the detection unit 8, a conventionally known angle sensor can be used, and a similar effect can be obtained by a method of measuring electric resistance, a combination of a magnet and a magnetic sensor, or the like. Note that by using a non-contact detection means such as the magnetic sensor, a photosensor, or an ultrasonic sensor, generation of a frictional force in the detection unit can be suppressed, and accuracy of torque measurement can be improved.

The line-winding device 100 according to an embodiment of the present invention is a line-winding device for fishing capable of being fixed to a fishing rod, the line-winding device comprising: a spool capable of winding a fishing line around a central axis substantially parallel to an extending direction of the fishing rod; a rotor comprising a guide part for guiding the fishing line and rotatable around the spool; an operating part for rotationally operating the guide part; and a switching part for switching availability of guiding by the guide part, and configured to comprise: a support shaft portion that is disposed at a central axis of the spool and is rotatably supported with respect to a device main body; a restoration unit for applying a restoring force between the support shaft portion and the device main body; and a detection unit for detecting an angular position of the support shaft portion. Here, the device main body refers to a structural member (a portion that can be fixed to the fishing rod) of the line-winding device for fishing. Note that the line-winding device is not limited to one for fishing, and may be a winch for unloading as long as it has a similar structure. Further, in the line-winding device according to an embodiment of the present invention, the support shaft portion is configured such that a rotatable range of the support shaft portion is restricted by a rotation restricting part.

According to the line-winding device 100 of an embodiment of the present invention, it is possible to provide the line-winding device comprising the tension detection unit that can be incorporated in the reel, can be downsized, and can measure a tension with high accuracy even at the time of stopping without the need to bend the line path. Further, with the line-winding device 100 according to an embodiment of the present invention, the detection unit 8 can be disposed in the reel main body. When the detection unit 8 is provided near the spool, the detection unit 8 is disposed inside the rotor 4 that infinitely rotates with respect to the reel main body. Therefore, there is a problem that power supply to the detection unit 8 and communication with the detection unit 8 are difficult. On the other hand, as in an embodiment of the present invention, by disposing the detection unit 8 in the reel main body, wiring to the detection unit 8 is facilitated, and the power supply and communication to a microcomputer can be performed.

In the line-winding device 100 according to an embodiment of the present invention, the restoring force generation unit (restoration unit) 4 is the torsion spring.

In the line-winding device 100 according to an embodiment of the present invention, the detection unit 7 is a non-contact position detection means, and comprises a light emitting part for projecting light to the part to be detected 6, and a receiver for receiving light of the light emitting part.

In the line-winding device 100 according to an embodiment of the present invention, a permanent magnet is provided in the part to be detected 6, and the detection unit 7 is the non-contact position detection means, and is a magnetic detection unit for detecting magnetism of the permanent magnet provided in the part to be detected 6.

In the line-winding device 100 according to an embodiment of the present invention, a sound wave reflecting part is provided in the part to be detected 6, and the detection unit 7 is the non-contact position detection means, and is a sound wave detection unit for detecting a sound wave from the sound wave reflecting part provided in the part to be detected 6.

The line-winding device according to an embodiment of the present invention is a fishing reel. Further, the line-winding device according to an embodiment of the present invention is a winch.

Next, a method for detecting a tension acting on the line by the line-winding device 100 according to an embodiment of the present invention will be described. As described above, in the line-winding device 100 according to an embodiment of the present invention, when the torque acts on the spool 1, the spool 1 moves in the rotation direction with respect to the support shaft portion 2 according to a magnitude of the torque. In an embodiment of the present invention, the restoration unit (restoration means) 6 is configured to have characteristics such that θ=0° when the magnitude of the torque is 10 gem or less, θ=60° when the magnitude of the torque is 100 gem or more, and the movement amount θ changes in proportion to a change amount of the torque between 0° and 60°.

The movement amount θ is detected by the detection unit 8, and an output of the detection unit 8 is observed, so that the torque acting on the spool 1 can be calculated. Note that the torque acting on the spool 1 is obtained by multiplying a tension T acting on the line by a winding radius R of the fishing line. The winding radius R of the fishing line can change according to a rotation amount of the spool 1, but the tension T acting on the fishing line can be calculated by obtaining the winding radius R of the line by another means.

In order to obtain the winding radius R of the fishing line, a conventionally known method can be used. For example, there are a method of measuring a distance from a line-winding device main body to the fishing line wound around the outer peripheral portion of the spool with an ultrasonic distance meter or the like, a method of calculating a line winding radius R by inputting a line winding radius Rmax and a thickness ΔD of the fishing line in an initial state in advance and constantly measuring the rotation amount of the spool 1 from the initial state, a method of using a shallow groove-shaped spool in which a change in the line winding radius can be ignored, and the like, but the present invention is not intended to be limited to a specific method.

In addition, as a method of using the detected tension, the torque acting on the spool 1 and information on the tension acting on the fishing line obtained by the above-described method can be transmitted to the user by being output to a display device such as an LCD or a sound information generation device such as a speaker. Thus, the presence or absence offish strike and the presence or absence of line slack can be determined, and a state of the line-winding device can be grasped.

Further, as a method of recording a history, the tension information may be transmitted to the microcomputer, and the history may be stored, for example, in an external device such as a memory or a smartphone. Thus, it is possible to grasp a change in a short period and a change in a long period which are difficult to visually recognize. Furthermore, the tension information may be used for a control object when performing feedback control of an external device such as a motor of the operating means or a drag device. Thus, various controls such as winding at a constant tension can be realized.

According to the line-winding device according to an embodiment of the present invention, the detection unit 8 can be disposed in the reel main body, and thus the power supply to the detection unit 8 can be easily performed, and when a substrate comprising a microcomputer or the like is disposed in the reel main body, there is an advantage, for example, that detected information can be transmitted by wire.

Next, according to the line-winding device according to an embodiment of the present invention, the tension acting on the line can be measured without bending the line path as compared with a method of bending the line. Thus, a mechanism for bending the line path is not necessary, and an increase in size of the entire device can be avoided. Further, since there is no unnecessary bent point in the line path, it is possible to avoid being an obstacle when the line comes out at high speed at the time of casting or the like.

In the line-winding device according to an embodiment of the present invention, as compared with a method of detecting a strain and displacement of a reel constituent member, a straight-running member is configured to move in the axial direction according to a torque applied to the spool, and the torque can be obtained by detecting a movement amount in the axial direction. It is often difficult to apply the tension to the spool by a method other than increasing a line tension due to a structure of the line-winding device, and the spool is not torqued even when an external force is applied to the line-winding device main body. Thus, it is possible to realize torque measurement and tension measurement that are stable against external disturbances as compared with a method of detecting strain of a main body frame or the like that pivotally supports the spool.

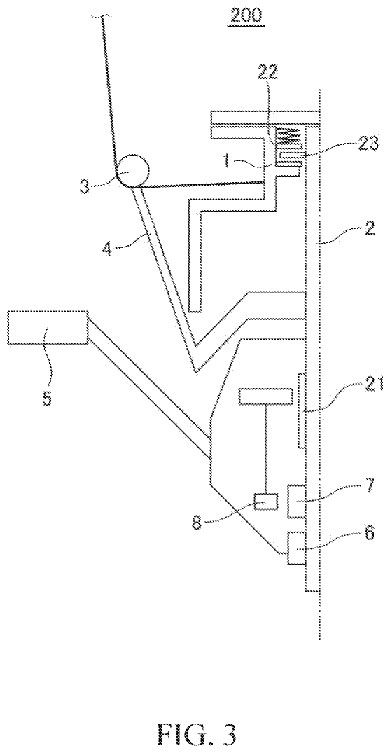

Next, a line-winding device 200 according to an embodiment of the present invention will be described with reference to FIG. 3. Note that the same components and members as those in the above embodiments are denoted by the same reference numerals, and description thereof will be omitted.

As illustrated in FIG. 3, the line-winding device 200 for fishing according to an embodiment of the present invention comprises the spool 1, the support shaft portion (support shaft) 2, the rotor 4 having the line guide 3, the handle 5 for operating the rotor 4, the restoration unit (restoration means) 6, the part to be detected (means to be detected) 7, the detection unit (detection means) 8, a level wind device 21, and a front drag device 24 comprising a spool-side drag member 22 and a main body-side drag member 23.

The level wind device 21 reciprocates the support shaft portion (support shaft) 2 in the axial direction in accordance with a rotation of the rotor 4 to evenly wind the fishing line around the spool 1. Since it can be realized by a conventionally known method such as rotating a worm gear by the operating part (operating means) 4, a detailed description thereof will be omitted.

The front drag device 23 is a conventionally known drag device capable of idling the spool 1 when a predetermined torque or more is applied to the spool 1. It comprises the spool-side drag member 22 that rotates integrally with the spool 1 and the main body-side drag member 23 that rotates integrally with the support shaft 2. In an embodiment of the present invention, a friction torque is generated between the spool-side drag member 22 and the main body-side drag member 23. It comprises a drag spring that generates the frictional force, and a drag screw that adjusts a charge amount of the drag spring. Note that the drag device according to an embodiment of the present invention is not limited to this friction method, and other conventionally known means such as generating a drag force by a method using a magnetorheological fluid and a magnetic force generation means may be used, and is not limited to a specific mode.

Even when the front drag device 23 is used in an embodiment of the present invention, it is possible to detect torque information and tension information generated in the spool 1 as in the above embodiment. That is, the support shaft portion 2 is supported by the rotation restricting part 11 so as to be rotatable within a predetermined angle range with respect to the reel main body. When the torque acting on the spool 1 is equal to or less than a set value of the drag device, the spool-side drag member 22 and the main body-side drag member 23 operate as one, resulting in the same relationship as in the above-described embodiment. When the torque acting on the spool 1 is equal to or more than the set value of the drag device, the spool 1 starts idling, but a torque corresponding to the set value of the drag device acts on the main body-side drag member 23. The torque is also transmitted to the restoration unit 6, and the support shaft 2 rotates by θ° according to the value. The value can be detected by the rotation detection unit 8.

Further, even when the level wind device 21 is provided in an embodiment of the present invention, it is possible to detect the torque information and the tension information generated in the spool 1 as in the above embodiment. In this case, the support shaft portion 2 moves in a vertical direction by the level wind device 21. Therefore, it is preferable that the detection unit 8 can detect only the movement of the support shaft portion 2 in the rotation direction. For example, a countermeasure of making the part to be detected 7 longer than a vertical movement amount by the level wind device 21 or a countermeasure of informing only the movement of the support shaft 2 in the rotation direction to the part to be detected 7 and sliding the part in the axial direction can be useful.

In an embodiment of the present invention, the drag device is disposed in the spool, and the detection unit 8 is disposed in a rear portion of the device main body. Thus, respective functions can be arranged independently. In order to increase a torque capacity that can be transmitted by the drag device, it is necessary to increase the number or an outer diameter of the drag member that generates the friction torque, and a predetermined volume is required. By disposing the drag device in the spool as in an embodiment of the present invention, it is possible to efficiently dispose the drag device having a predetermined torque capacity in terms of space. In addition, by disposing the detection unit 8 on the reel main body, it is possible to avoid being affected by a size of the drag device, and thus it is possible to minimize an increase in size of the entire device.

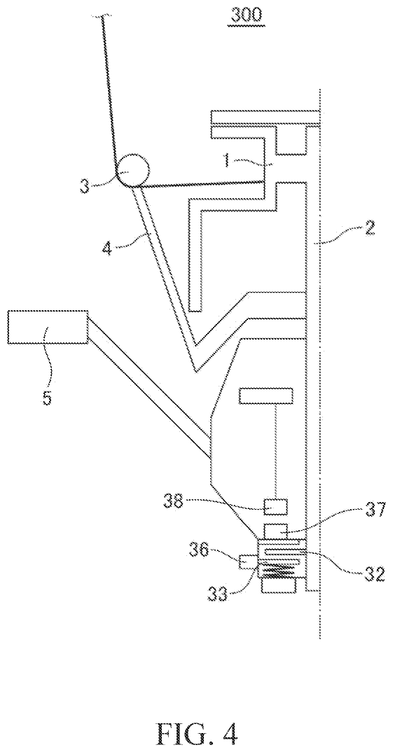

Next, a line-winding device 300 according to an embodiment of the present invention will be described with reference to FIG. 4. Note that the same components and members as those in the above embodiments are denoted by the same reference numerals, and description thereof will be omitted.

As illustrated in FIG. 4, the line-winding device 300 for fishing according to an embodiment of the present invention comprises the spool 1, the support shaft portion (support shaft) 2, the rotor 4 having the line guide 3, the operating part 5 (for example, the handle) for operating the rotor 4, a restoration unit (restoration means) 36, a pail to be detected (means to be detected) 37, a detection unit (detection means) 38, the level wind device 21, and a rear drag device 34 comprising a spool-side drag member 32 and a main body-side drag member 33.

The support shaft 2 in an embodiment of the present invention rotates in synchronization with the spool 1 as in a first embodiment described above. When excessive torque is applied to the spool 1, the spool 1 and the support shaft portion 2 are idled by the rear drag device 34 provided between the reel main body and the support shaft portion.

The rear drag device 34 comprises the spool-side drag member 32 that rotates integrally with the spool 1 and the support shaft portion 2, and the main body-side drag member 33 that rotates substantially integrally with the reel main body. As in the above-described embodiment, a predetermined drag force can be set between the spool-side drag member 32 and the main body-side drag member 33 by a conventionally known means, and a relative rotation is performed when the torque reaches a predetermined value or more.

In an embodiment of the present invention, the spool-side drag member 32 is configured to receive transmission only in the rotation direction from the support shaft and not to transmit an axial movement so as not to reciprocate by the level wind device 21 Then, the main body-side drag member 33 is rotatably supported with respect to the reel main body. The main body-side drag mechanism is rotatable within a set angle range (for example, a range of θ=0° to 60°) by the rotation restricting unit provided on the reel main body. Then, it receives the restoring force in the rotation direction by the restoration unit (restoration unit) 36. The part to be detected 37 is provided in the main body-side drag mechanism 33, and an angular movement amount θ of the main body-side drag member 33 with respect to the reel main body can be detected by the detection unit 8.

With the above configuration, effects similar to those of the above-described embodiments can be realized. That is, when the torque acting on the spool 1 is equal to or less than the set value of the drag device, the spool 1 and the main body-side drag member 33 rotate integrally, so that a mechanism similar to that in the first embodiment can be obtained and detection can be performed. When the torque acting on the spool 1 is equal to or more than the set value of the drag device, the spool 1, the support shaft portion 2 and the spool-side drag member 32 integrally rotate relative to the main body-side drag member 33. Also at this time, the torque corresponding to a set torque of the drag device is transmitted to the main body-side drag member 33, and the main body-side drag member moves to a position balanced with the restoration unit (restoration means). The torque and the tension acting on the spool 1 can be detected by detecting the balance position by the detection unit 8.

Dimensions, materials, and arrangements of the components described in this specification are not limited to those explicitly described in the embodiments, and the components may be modified to have any dimensions, materials, and arrangements that may fall within the scope of the present invention. Further, components not explicitly described herein can be added to the described embodiments, or some of the components described in each embodiment can be omitted.

### REFERENCE SIGNS LIST

1 spool
2 support shaft portion (support shaft)
3 line guide (guide part)
4 rotor
operating part
6 restoration unit (restoration means)
7 part to be detected (means to be detected)
8 detection unit (detection means)
11 rotation restricting part
12 movable-side spring end
13 fixed-side spring end
22 spool-side drag member
23 main body-side drag member
32 spool-side drag member
33 main body-side drag member
36 restoration unit (restoration means)
37 part to be detected
38 detection unit
100 line-winding device
200 line-winding device
300 line-winding device

1. A line-winding device capable of being fixed to a fishing rod, the line-winding device comprising:
a spool capable of winding a fishing line around a central axis substantially parallel to an extending direction of the fishing rod; a rotor comprising a guide part for guiding the fishing line and rotatable around the spool; an operating part for rotationally operating the guide part; and a switching part for switching availability of guiding by the guide part, and comprising:
a support shaft portion that is disposed at a central axis of the spool and is rotatably supported with respect to a device main body; a restoration unit for applying a restoring force between the support shaft portion and the device main body; and a detection unit for detecting an angular position of the support shaft portion.

2. The line-winding device according to claim 1, wherein a rotatable range of the support shaft portion is restricted by a rotation restricting part.

3. The line-winding device according to claim 1, wherein the restoration unit is an elastic spring.

4. The line-winding device according to claim 1, wherein the detection unit is a non-contact position detection means, and comprises a light emitting part for projecting light to a part to be detected, and a receiver for receiving light of the light emitting part.

5. The line-winding device according to claim 1, wherein
a permanent magnet is provided in a part to be detected, and
the detection unit is a non-contact position detection means, and is a magnetic detection unit for detecting magnetism of the permanent magnet provided in the part to be detected.

6. The line-winding device according to claim 1, wherein
a sound wave reflecting part is provided in a part to be detected, and
the detection unit is a non-contact position detection means, and is a sound wave detection unit for detecting a sound wave from the sound wave reflecting part provided in the part to be detected.

7. A fishing reel, wherein the line-winding device according to claim 1 is the fishing reel.

8. A winch, wherein the line-winding device according to claim 1 is the winch.
